(19) United States
(12) Patent Application Publication
(10) Pub. No.: US 2013/0307235 A1
(43) Pub. Date: Nov. 21, 2013

(54) Removable Nest Wire for a Shopping Cart

(71) Applicant: UNARCO INDUSTRIES, LLC., Wagoner, OK (US)

(72) Inventors: Woody Smith, STILLWATER, OK (US); WESLEY McMURTREY, WAGONER, OK (US)

(21) Appl. No.: 13/887,649

(22) Filed: May 6, 2013

Related U.S. Application Data
(60) Provisional application No. 61/648,973, filed on May 18, 2012.

(51) Int. Cl. B62B 3/14

(52) U.S. Cl. CPC B62B 3/1496; B62B 2205/30
USPC 280/33.991

(57) ABSTRACT

A wheeled shopping cart with a rotatable rear panel or side is provided with a field-installable, field removable nest wire. Removing the nest wire enables the front portion of the wheeled shopping cart to be more compactly telescoped into the rotatable rear panel of another, similar shopping cart, the nest wire of which is removed. Installing the nest wire post-manufacture and at the location where the cart will be used enables multiple carts to be nested or telescoped into each other, more compactly than would be possible with the nest wire installed.

### BACKGROUND

Shopping carts, which are comprised of a wheeled frame to which a wire-mesh basket is affixed, are relatively light but nevertheless bulky. While they are designed to be telescoped together, i.e., placing the front end of the basket into a movable rear panel, wire-mesh shopping carts are relatively difficult to economically package and ship in their assembled state. A method and apparatus for facilitating the shipment of frame and basket portions in a reduced-size state would be an improvement over the prior art.

### BRIEF DESCRIPTION OF THE FIGURES

FIG. 1 is a perspective view of a prior art shopping cart;

FIG. 2A and FIG. 2B are side and top views respectively of shopping carts nested together with a nest wire installed on each cart;

FIG. 3A and FIG. 3B are side and top views respectively of shopping carts nested together without a nest wire on any of the carts;

FIG. 4 is an isolated perspective view of a tubular frame for a shopping cart showing the attachment of a nest wire that is field installable and field removable;

FIG. 5A is a side view of the frame shown in FIG. 4;

FIG. 5B is a isolated view of detail C shown in FIG. 5A;

FIG. 6A is a top view of a field-installable and removable nest wire;

FIG. 6B is a side view of a field-installable and removable nest wire shown in FIG. 6A;

FIG. 7 is an isolated view of one end of a field-installable and removable nest wire and a nest wire click lock that is configured to be attached to a frame and to receive one end of the field-installable nest wire;

FIG. 8A is an exploded view of the field-installable and removable nest wire positioned for placement into click locks;

FIG. 8B is an assembled view showing the field-installable and replaceable nest wire installed into the click locks;

FIG. 9A is a perspective view of a nest wire showing both ends installed in a click lock;

FIG. 9B is an isolated view of a click lock showing a retaining clip;

FIG. 10A is a top view of a click lock; and

FIG. 10B is a side view of a click lock.

### DETAILED DESCRIPTION

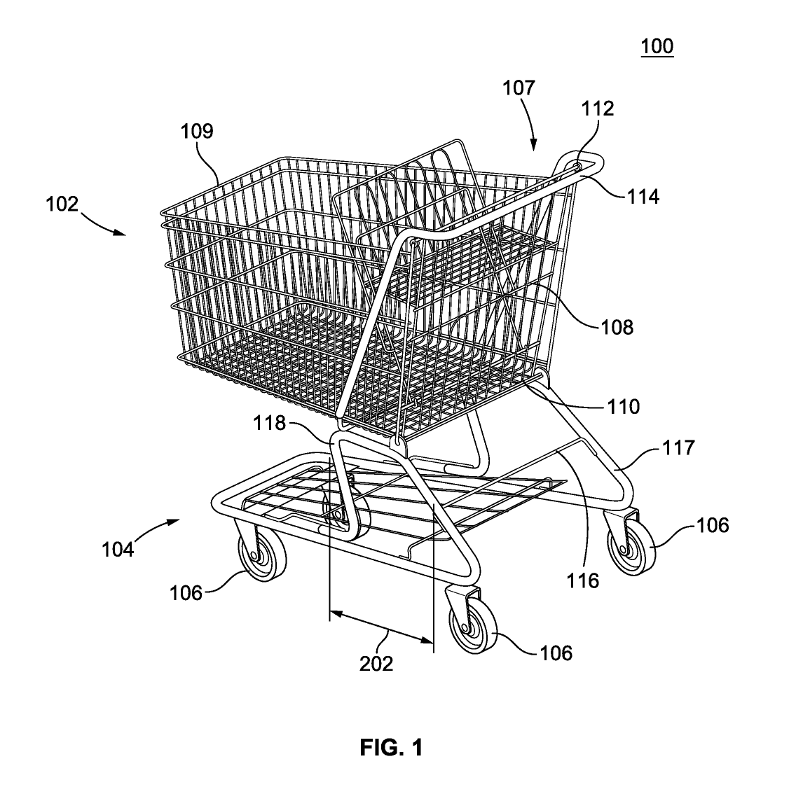

FIG. 1 is a perspective view of a shopping cart 100. The cart 100 is comprised of a basket portion 102 attached to a frame portion 104. The frame portion 104 is provided with wheels 106, which allow the cart 100 to be wheeled about.

The basket portion 102 has a rear panel or door 108, the bottom 110 of which is able to pivot upwardly, when the rear panel 108 rotates around hinges 112 that are provided to the rear panel 108 near the top 107 of the basket 102. The hinges 112 are depicted in the figure as being in front of a user handle 114. The rear panel 108 is thus able to rotate upwardly or forwardly in a clockwise direction as shown in FIG. 1 to allow multiple carts 100 to be nested one inside the other.

Nesting carts 100 inside each other enables several of them to be stored in a smaller area than would otherwise be required to store the carts, end-to-end, i.e., with the front panel 109 of one cart 100 rested or abutting against the back panel 108 of another cart. When carts are nested, the front end 109 of one cart 100 is pushed into the back panel 108 of a second cart, which causes the back panel 108 of the second cart to rotate around the aforementioned hinges 112. In so doing, an upright tubular portion 118 of the frame 104 of a first cart will abut or run into a nest wire 116 of the cart in front of it. The nest wire 116 thus limits the distance into which one cart can be pushed into another.

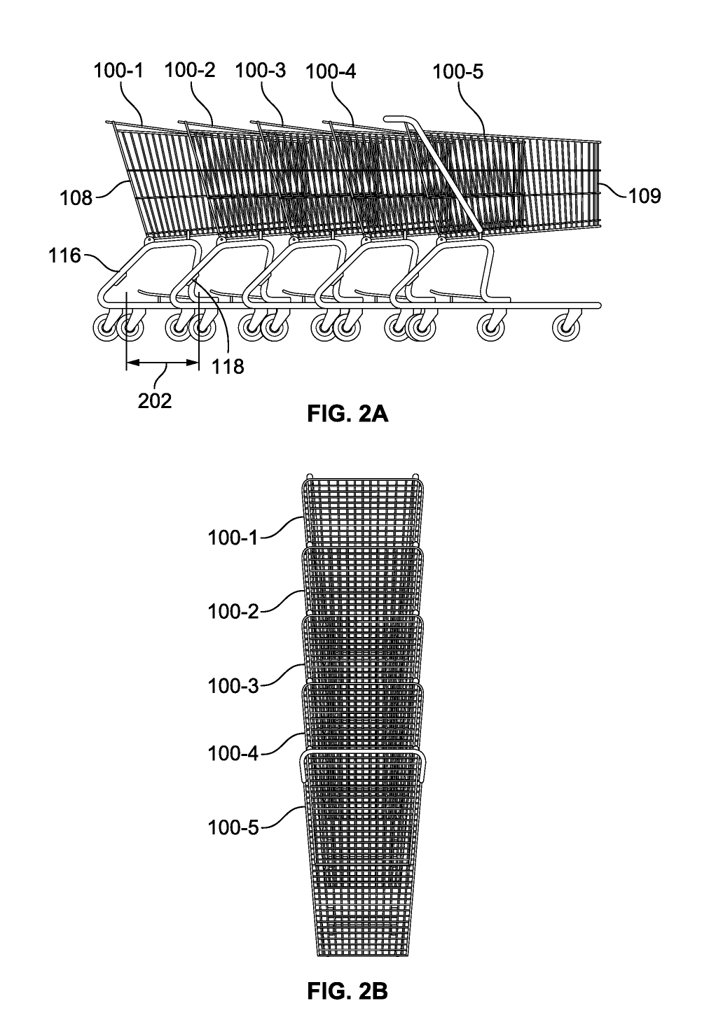

FIG. 2A is a side view of several carts 100-1 through 100-5 nested together. The front panel 109 of each of the first four carts 100-1 through 100-4 is pushed into or nested into the rear panel 108 of the second cart 100-2 through fifth cart 100-5.

Pushing the front panel 109 of a first cart too far into the rear panel 108 of a second cart can be problematic because carts that are too tightly nested can be difficult to separate. Prior art carts are therefore manufactured to limit the distance by which the carts are able to be nested into each other.

As shown in FIG. 1, a field-installable, field-removable nest wire 116 attached to the inclined rear tubes 117 of the frame portion 104, stops the upright tubes 118 of a cart inserted into the rear panel 108. As used herein, a nest distance 202 (See FIG. 2.) is considered to be the distance between a nest wire 116 and tubes 118 of frame that will abut or stop against the nest wire 116 of a cart. FIG. 2B is a top view of the five nested baskets, which are identified by reference numerals 100-1 through 100-5.

As shown in FIG. 2A, the nest distance 202 with a nest wire 116 installed on each basket is about 13 inches. As shown in FIG. 2B, the overall length of five nested carts with a nest wire installed on each basket is about 90.6 inches.

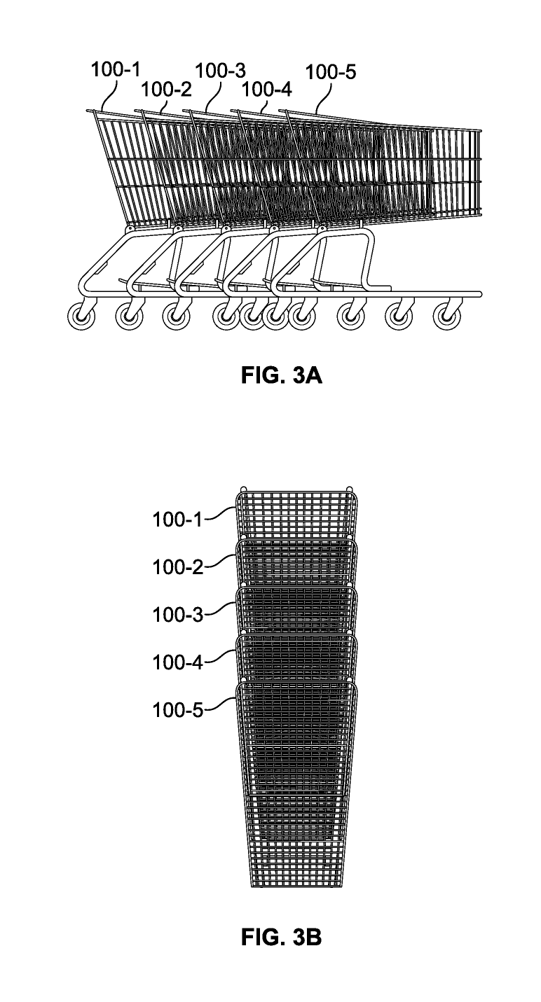

FIG. 3A depicts the same five carts of FIGS. 2A and 2B, nested together without a nest wire on any of the frames. When the nest wire 116 is removed from each cart 100-1 through 100-5, the same five carts 100-1 through 100-5 can be nested more closely together. The nest distance 202 without the nest wire 116 installed on each of the frames 104 is reduced to about 8.5 to about 9 inches. Nesting the carts without a nest wire thus reduces the nest distance 202 by about thirty-five percent.

FIG. 3B is a top view of the nesting of the five carts shown in FIG. 3A. The overall length of five nested carts is reduced to just over seventy-two inches. Removing the nest wire 116 from a shopping cart thus significantly reduces nest distance 202. Removing the nest wire 116 also significantly reduces the overall length of two or more nested carts.

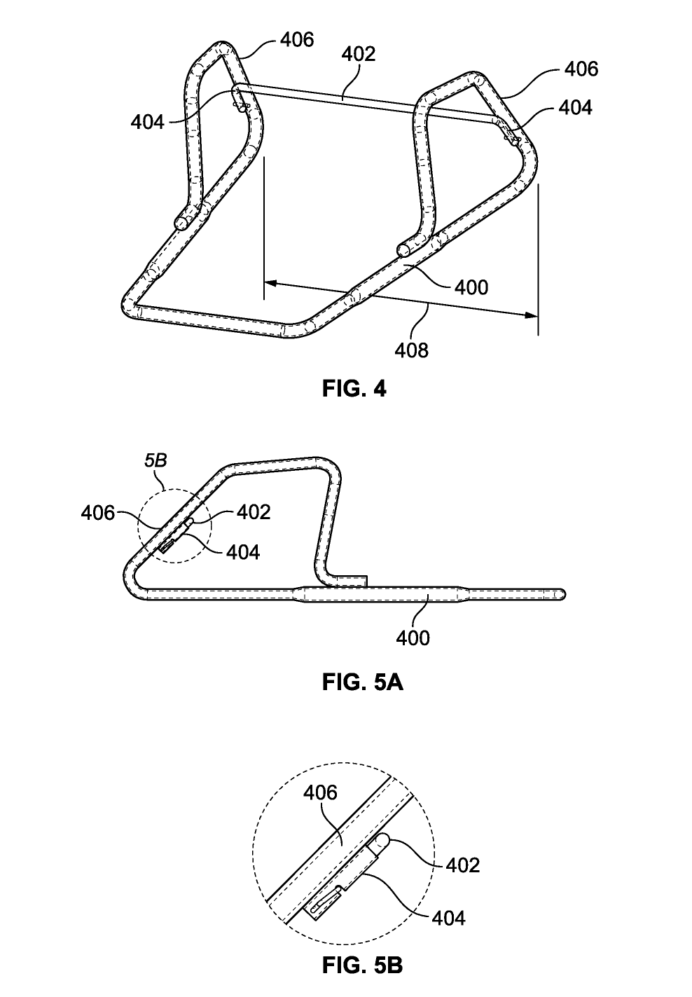

FIG. 4 is a perspective view of a tubular frame 400 for a shopping cart having a field-installable and field-removable nest wire 402. A field-installable nest wire 402 is one that can be installed onto the frame 400 of a shopping cart by hand, which means without tools or other special equipment. A field-removable nest wire 402 is one that can also be removed from the cart frame at any time after manufacture, by hand, i.e., without special tools or special equipment.

The field installation of a nest wire 402 is provided in part by way of two “click locks” 404, the shapes of which are configured to receive a nest wire 402 and which are reminiscent of a cylinder. The field-removability of a nest wire 402 is also provided by the click locks 404.

The click locks 404 are rigidly attached to the frame 400, preferably by welding. They permit the nest wire 402 to be installed and removed without special tools. Stated another way, the nest wire installation and removal can be accomplished by hand or with only common tools that include pliers and a mallet or hammer.

FIG. 5A is a side view of the frame 400 shown in FIG. 4. A click lock 404 is welded to an inclined rear section 406 of the frame 400. FIG. 5B is an isolated view of detail C showing the attachment of the click lock 404 to the inclined portion 406 of the frame 400.

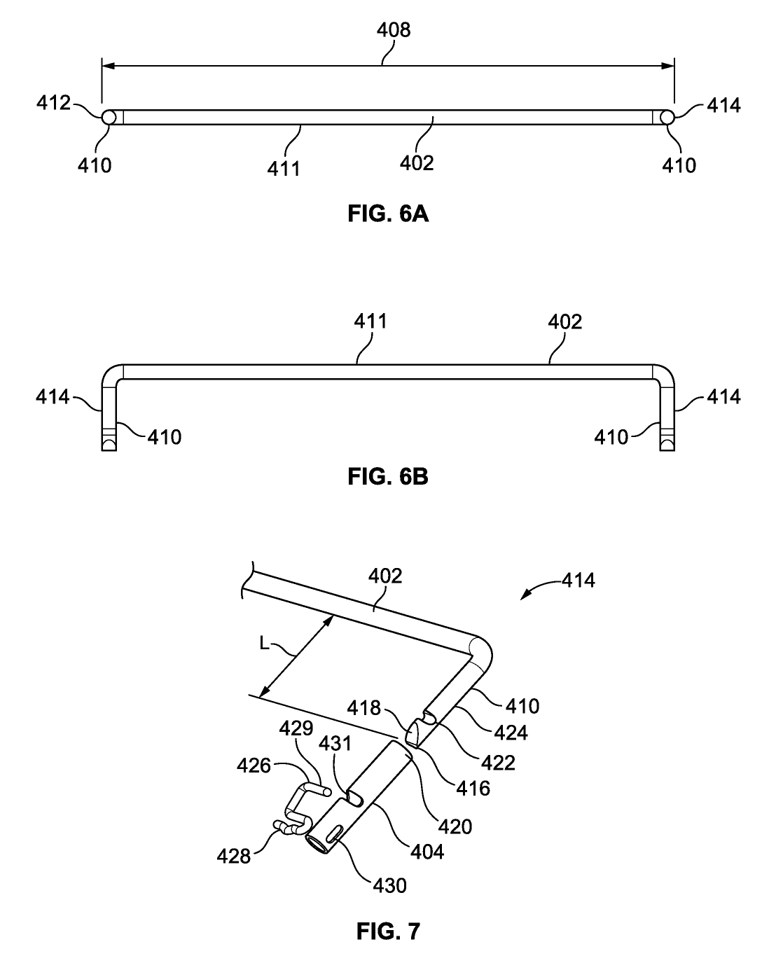

FIG. 6A is a top view of a U-shaped, field-installable, field-replaceable nest wire (nest wire) 402. FIG. 6B is a side view of the nest wire 402. The nest wire 402 has an overall length 408 defined as the distance between two, nest wire locking sections 410 that are located at each of the two ends 412 and 414, of the wire 402. The length 408 of the nest wire 402 corresponds to and is substantially equal to the space between two inclined portions 406 of a frame 400. FIG. 6A shows that the nest wire locking sections 410 and an elongated center portion 411 are substantially co-planar. FIG. 6B shows that the nest wire 402 is substantially U-shaped.

FIG. 7 is an isolated view of the second end 414 of the nest wire 402 shown in FIGS. 6A and 6B. The locking section 410, which is orthogonal to the center portion 411, has an overall length “L” which in the preferred embodiment is between about two inches and about four inches. A far or distal end 416 of the locking section 410 is provided with a chamfer or taper to facilitate insertion of the locking section 410 into substantially circular opening 420 of a click lock 404. A groove or slot 422 is cut or otherwise formed into a shank region 424 of the locking section 410. The groove or slot 422 is configured to receive a locking pin 426, after the locking section 410 is inserted into the click lock 404.

The locking pin 426 has a shape reminiscent of the Arabic letter “S.” The locking pin 426 has a first end 428 configured to fit into a slot or notch 430 formed through the bottom end of the click lock 404. A somewhat rod-like second end 429 fits into a groove 431 formed into the body of the click lock and into a groove 422 formed into the locking section 410.

The locking pin 426 is sized, shaped and arranged to removably hold the locking section 410 of the nest wire 426 in the click lock 404. As used herein, the term, “removably hold” means that the locking pin 426 can of course be installed into the click lock in order to hold the locking section 410 into the click lock 404, however, the locking pin 426 is also removable from the click lock. Removing the locking pin 426 from the click lock 404 enables the nest wire to be removed from the click lock.

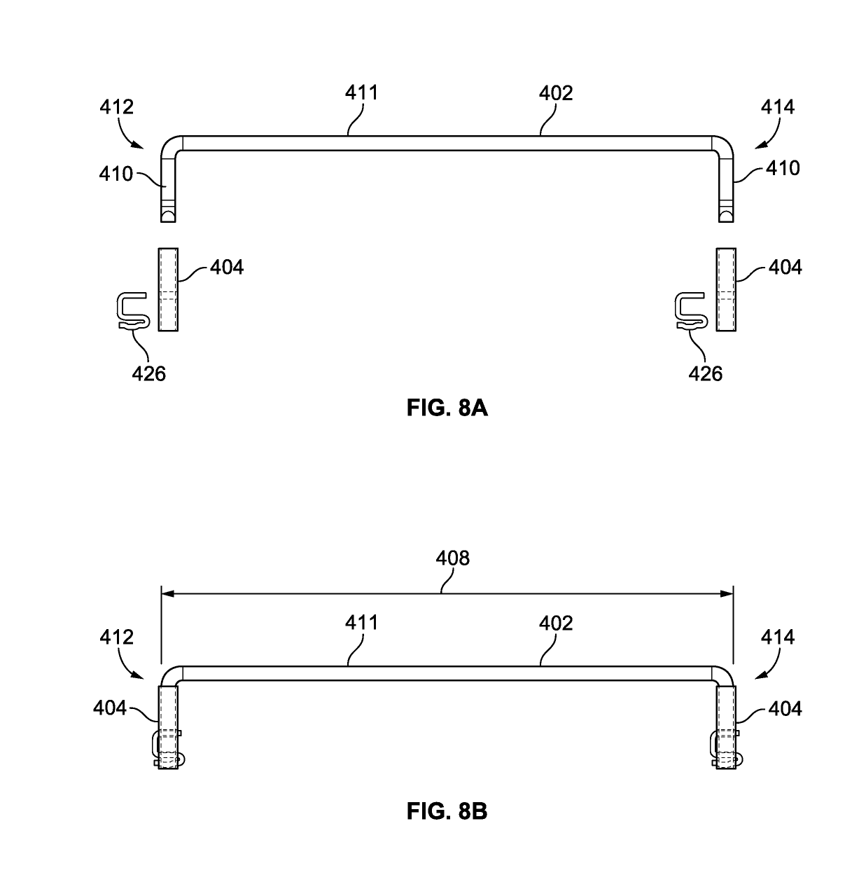

FIG. 8A is an exploded view of the U-shaped nest wire 402 positioned to be installed into click locks 404. The locking pins 426 are shown as being located for insertion into the holes 430 into the click lock bodies. FIG. 8B is an assembled view of the nest wire 402 and click locks 404 and showing the nest wire 402 latched in place into the click locks 404.

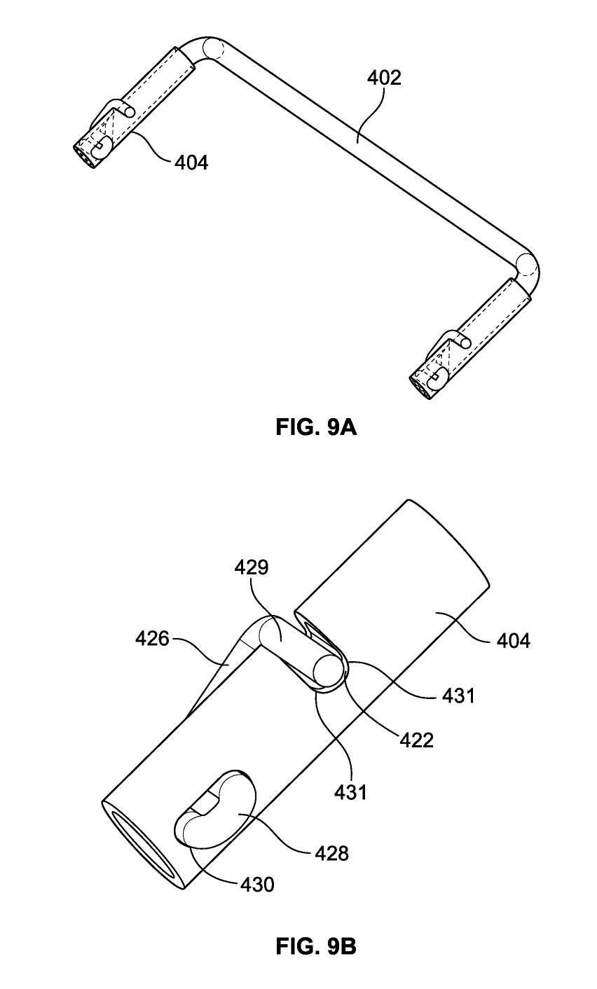

Referring now to FIG. 9, there is shown a click lock 404 having the latching pin 426 installed therein. The rod-like second end 429 fits into a notch or groove 431 formed in the click lock body at the same time that it fits inside of the mating notch 422 formed into the shank portion 424 of the locking section 410. The two notches 422 and 430 thus coincide with each other when the locking section 410 is properly installed into the click lock 404.

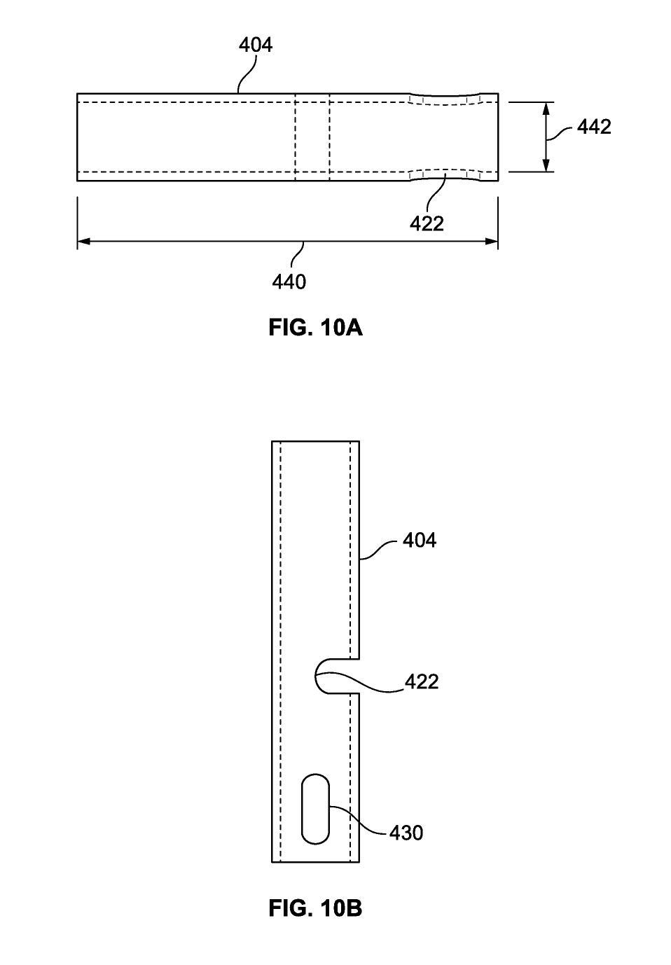

FIG. 10A is a top view of a click lock 402. The click lock 402 has an overall length 440 of approximately 4 inches, which is long enough to secure the locking section 410 of a nest wire 402. The click lock has an inside diameter 442 just large enough to receive the substantially circular cross-sectioned nest wire.

FIG. 10B is a side view of the click lock 402. An elongated hole 430 is formed into the side of the click lock body accompanied by a notch or slot 422.

Those of ordinary skill in the art will recognize that the click locks 404 have shapes reminiscent of cylinders. The cylinder-shaped click locks 404 are provided with a hole 430 and a notch or slot 422 that receive a locking pin 426. The locking pin 426 engages a nest wire 402 as well as the click lock 404. Once installed in the click locks, the pins prevent the nest wires from being removed.

While the preferred embodiment of the nest wire has a circular cross section, which mates with click locks having cylindrically-shaped interiors, alternate embodiments include nest wires with non-circular cross sections, examples of which include square, rectangular, triangular and elliptical cross sections. In other embodiments, a locking pin can be provided with a barb or an upset end configured to extend through slot 422. This embodiment of the locking pin would resemble the Arabic letter “C.”

While the materials for the nest wire and click lock are preferably metal, in alternate embodiments, one or both of them are made of plastic. In yet another embodiment, a factory-installed locking wire is installed in the click lock, the locking wire having an end bent 90 degrees and configured to trap the nest wire through the hole/slot 430 and provide sufficient spring tension across the 422 slot to retain the nest wire.

The foregoing description is purposes of illustration only. The true scope of the invention is set forth in the appurtenant claims.

What is claimed is:

1. A shopping cart comprising:
a field-installable, field removable nest wire.

2. The shopping cart of claim 1, further comprising:
at least one click-lock, configured to receive the field-installable, field-removable nest wire.

3. The shopping cart of claim 2, wherein the shopping cart is comprised of a frame and configured to provide a nest distance of less than about nine inches.

4. The shopping cart of claim 1, wherein the field-removable, field-installable nest wire has a shape reminiscent of the Arabic letter “U.”

5. The shopping cart of claim 2, wherein the field-removable, field-installable nest wire has at least one locking section comprised of a chamfer, the chamfer being configured to facilitate insertion of the locking section into the click lock.

6. The shopping cart of claim 2, further comprising a locking pin, configured to removably hold a locking section of the nest wire in the click lock.
